(19) United States
(12) Patent Application Publication
(10) Pub. No.: US 2026/0005218 A1
(43) Pub. Date: Jan. 1, 2026

(54) LITHIUM SULFUR BATTERY ELECTRODE PROCESS

(71) Applicant: UNIVERSITY OF SOUTH CAROLINA, COLUMBIA, SC (US)

(72) Inventors: GOLAREH JALILVAND, IRMO, SC (US); WILLIAM MUSTAIN, BLYTHEWOOD, SC (US); SAHEED LATEEF, COLUMBIA, SC (US); MARJANUL MANJUM, COLUMBIA, SC (US)

(21) Appl. No.: 18/854,167

(22) PCT Filed: Apr. 6, 2023
(86) PCT No.: PCT/US2023/017688

§ 371 Date: Oct. 4, 2024

Related U.S. Application Data
(60) Provisional application No. 63/327,998, filed on Apr. 6, 2022.
(60) Provisional application No. 63/414,299, filed on Oct. 7, 2022.

(51) Int. Cl. H01M 4/04; H01M 4/36; H01M 4/58; H01M 4/587; H01M 10/0567; H01M 10/0568

(52) U.S. Cl. CPC H01M 4/0419; H01M 4/366; H01M 4/5815; H01M 4/5825; H01M 4/587; H01M 10/0567; H01M 10/0568; H01M 2300/0025

(57) ABSTRACT

In general, the present disclosure is directed to methods and compositions for producing a sulfur cathode. The method includes dry mixing sulfur particles and a binder; adding a carbon source to the dry mixture; contacting the resulting dry mixture comprising the carbon source, the sulfur particles, and the binder with a solvent to form a cathode slurry; and removing the solvent from the cathode slurry to form the sulfur cathode, wherein the sulfur cathode comprises a porous shell structure covering the sulfur particles.

### CROSS REFERENCE TO RELATED APPLICATION

This application is the national stage entry of International Patent Application No. PCT/US2023/017688 having a filing date of Apr. 6, 2023, which claims the filing benefit of U.S. Provisional Patent Application Ser. No. 63/327,998, having a filing date of Apr. 6, 2022, and of U.S. Provisional Patent Application Ser. No. 63/414,299, having a filing date of Oct. 7, 2022, both of which are incorporated herein by reference for all purposes.

### BACKGROUND

Sulfur is a promising candidate for next-generation cathodes in lithium battery systems, and lithium-sulfur (Li—S) batteries are one of the promising alternatives for current lithium-ion battery (LIB) technology due to their superior specific energy density, which can satisfy the emerging needs of advanced energy storage applications such as electric vehicles and grid-scale energy storage and delivery. However, achieving this high specific energy density is hampered by several challenges inherent to the properties of sulfur and its discharge products.

One major issue is related to the insulating nature of sulfur and its fully discharged product (Li₂S), which often leads to low utilization of the active material and poor rate capability. The poor electronic conductivity of these species can be overcome by utilizing conductive hosts, though they are dilutive and decrease the energy density, meaning that their mass ratio to the active material should be as low as possible.

Another issue relates to the undesired solubility of certain sulfur discharge products, so-called long-chain Li polysulfides (LiPSs), in the conventional ether-based liquid electrolyte. The solubility of long-chain LiPSs promotes their free back and forth transportation between the positive and negative electrodes, which results in poor cyclability and capacity decay. Lastly, sulfur goes through a large volume expansion during discharge that leads to mechanical degeradation in the cathode over long duration cycling. Despite the efforts to engineer and control the undesired LIPSs shuttling effect and volume variation-induced degradations, the advances have been mostly limited to a small number of cycles (100-200), or to the need for complex and often expensive synthesis that has limited the rational development of new sulfur cathodes.

At present, a large majority of the sulfur cathode research has focused on nano-architectured electrodes using 2D and 3D host materials for sulfur, such as carbon nanotubes, graphene, conductive scaffolds, yolk-shell structures, and the like, to increase the conductivity, alleviate the LiPSs shuttling, and accommodate the volume variation during discharge. Although these approaches have helped to increase the achievable capacity, and sometimes the cyclability, their synthesis methods have been highly complex, meaning that their manufacturing cost will be high. Also, in operating cells, it is highly unlikely that these complex structures can be effectively reproduced upon many charge-discharge cycles-meaning that capacity loss is essentially inevitable. Thus, developing novel, yet affordable and scalable, cathode architectures that can enhance the rapid transport of Li-ions to active sites for electrode reactions, accommodate discharge-induced volume expansion, and minimize the shuttling mechanism by sulfur encapsulation are still in great need. Relatively simple and low-cost processing methods to create electrodes that allow for significantly improved cycling and lifetime would be of great benefit in the art.

### SUMMARY

In general, the present disclosure is directed to a method of producing a sulfur cathode. The method includes dry mixing sulfur particles and a binder; adding a carbon source to the dry mixture; contacting the resulting dry mixture comprising the carbon source, the sulfur particles, and the binder with a solvent to form a cathode slurry; and removing the solvent from the cathode slurry to form the sulfur cathode, wherein the sulfur cathode comprises a plurality of particles, each particle including a porous shell structure covering one or more of the sulfur particles.

Also, the present disclosure is directed to an electrochemical cell. The electrochemical cell includes a sulfur cathode comprising a plurality of particles, each particle comprising a porous shell structure covering one or more sulfur particles; an anode comprising of lithium or a lithiated oxide material; and an electrolyte.

These and other features and aspects, embodiments and advantages of the present invention will become better understood with reference to the following description and appended claims.

### BRIEF DESCRIPTION OF THE FIGURES

A full and enabling disclosure of the present disclosure is set forth more particularly in the remainder of the specification, including reference to the accompanying figures, in which:

FIG. 1A depicts the scanning electron microscopy (SEM) images of the sulfur cathode processed-coated through conventional method-doctor blade.

FIG. 1B depicts the scanning electron microscopy (SEM) images of the sulfur cathode processed-coated through conventional method-doctor blade.

FIG. 1C depicts the scanning electron microscopy (SEM) images of the sulfur cathode processed-coated through conventional method-spray.

FIG. 1D depicts the scanning electron microscopy (SEM) images of the sulfur cathode processed-coated through conventional method-spray.

FIG. 1E depicts the scanning electron microscopy (SEM) images of the sulfur cathode processed-coated through CBAD method-doctor blade.

FIG. 1F depicts the scanning electron microscopy (SEM) images of the sulfur cathode processed-coated through CBAD method-doctor blade.

FIG. 1G depicts the scanning electron microscopy (SEM) images of the sulfur cathode processed-coated through CBAD method-spray.

FIG. 1H depicts the scanning electron microscopy (SEM) images of the sulfur cathode processed-coated through CBAD method-spray.

FIG. 2 depicts the capacity retention of the LSB cells that were prepared using different slurry preparation and coating methods.

FIG. 3A depicts Galvanostatic charge-discharge profiles of the LSB cells prepared by conventional method-doctor blade.

FIG. 3B depicts Galvanostatic charge-discharge profiles of the LSB cells prepared by conventional method-spray.

FIG. 3C depicts Galvanostatic charge-discharge profiles of the LSB cells prepared by CBAD-doctor blade.

FIG. 3D depicts Galvanostatic charge-discharge profiles of the LSB cells prepared by CBAD-spray.

FIG. 4A depicts long cycle life performance of CBAD-spray electrode at C/10.

FIG. 4B depicts rate capabilities of CBAD-spray electrode at C/10, C/5, C/2, and 1 C.

FIG. 5A depicts Coulombic efficiency of sulfur cathodes cycled at C/10 for 300 cycles prepared by conventional method-doctor blade.

FIG. 5B depicts Coulombic efficiency of sulfur cathodes cycled at C/10 for 300 cycles prepared by conventional method-spray.

FIG. 5C depicts Coulombic efficiency of sulfur cathodes cycled at C/10 for 300 cycles prepared by CBAD method-doctor blade.

FIG. 5D depicts Coulombic efficiency of sulfur cathodes cycled at C/10 for 300 cycles prepared by CBAD method-spray.

FIG. 6A depicts SEM images of the CM-W-1-based electrode.

FIG. 6B depicts SEM images of the PA-W-1-based electrode.

FIG. 6C depicts SEM images of the PV-W-1-based electrode.

FIG. 6D depicts SEM images of the CMC-based electrode.

FIG. 6E depicts SEM images of the PAA-based electrode.

FIG. 6F depicts SEM images of the PVP-based electrode.

FIG. 7A depicts SEM images of the CM-W-1-based electrode with incipient NMP.

FIG. 7B depicts SEM images of the PA-W-1-based electrode with incipient NMP.

FIG. 7C depicts SEM images of the PV-W-1-based electrode with incipient NMP.

FIG. 7D depicts SEM images of the CMC-based electrode with incipient NMP.

FIG. 7E depicts SEM images of the PAA-based electrode with incipient NMP.

FIG. 7F depicts SEM images of the PVP-based electrode with incipient NMP.

FIG. 8A depicts capacity retention of PAA-, PVP-, and CMC-based electrodes in a NMP-based system.

FIG. 8A depicts capacity retention of PAA-, PVP-, and CMC-based electrodes in a water-based system.

FIG. 8C depicts voltage profile of CMC with water- and NMP-based cathodes at the 2nd cycle.

FIG. 8D depicts voltage profile of PAA with water- and NMP-based cathodes at the 2nd cycle.

FIG. 8E depicts voltage profile of PVP with water- and NMP-based cathodes at the 2nd cycle.

FIG. 9A depicts SEM images of the precycled electrode with CM-N-2.

FIG. 9B depicts SEM images of the precycled electrode with PA-N-2.

FIG. 9C depicts SEM images of the precycled electrode with PV-N-2.

FIG. 9D depicts capacity retention plot of the Li—S cells.

FIG. 10A depicts SEM images of the precycled electrode with CM-N-3.

FIG. 10B depicts SEM images of the precycled electrode with PA-N-3.

FIG. 10C depicts SEM images of the precycled electrode with PV-N-3.

FIG. 11A depicts post mortem SEM images of pre-cycled cells with the shell covering PV-N-1 particles.

FIG. 11B depicts post mortem SEM images of the electrode surface after 20 discharge-charge cycles with the shell covering PV-N-1 particles.

FIG. 11C depicts post mortem SEM images after rinsing the cycled cells with the shell covering PV-N-1 particles.

FIG. 11D depicts post mortem SEM images of pre-cycled cells without the shell covering PV-N-3 particles.

FIG. 11E depicts post mortem SEM images of the electrode surface after 20 discharge-charge cycles without the shell covering PV-N-3 particles.

FIG. 11F depicts post mortem SEM images after rinsing the cycled cells without the shell covering PV-N-3 particles.

FIG. 12 illustrates the particle structural changes due to charge-discharge processes.

FIG. 13 illustrates the processing method of forming a sulfur cathode based on the conventional method compared to the “controlled binder-dissolution after dry-mixing (CBAD)” method.

FIG. 14 illustrates an electrochemical cell.

Repeat use of reference characters in the present specification and figures is intended to represent the same or analogous features or elements of the present disclosure.

### DETAILED DESCRIPTION

Reference will now be made in detail to example embodiments of the disclosure. It is to be understood by one of ordinary skill in the art that the present disclosure is a description of exemplary embodiments only and is not intended as limiting the broader aspects of the present disclosure.

In general, the present disclosure is directed to a simple and scalable method of producing sulfur cathodes. For instance, the method includes dry mixing sulfur particles and a binder; adding a carbon source to the dry mixture; and contacting the dry mixture with a solvent to form a cathode slurry. In one embodiment, the sulfur cathode comprises a plurality of particles, each particle including a porous shell structure covering one or more of the sulfur particles. The porous shell structure may include carbon of a carbon source and at least a portion of the binder. The degree of binder dissolution into the solvent is limited to control the diffusion of solvent into the polymer chains of the binder. The degree of dissolution can be set by several variables, including the solvent-to-binder ratio, temperature, time, degree of agitation/mixing, presence of surfactants or other dissolved species, and presence of secondary solid additives. From this process, a solid swollen network of binder can be achieved that adheres to the sulfur and carbon particles. The swollen network also may provide a buffer for volume expansion during discharge and impede dissolution of the discharge products (e.g., soluble polysulfides) into the electrolyte by physical trapping. Embodiments can provide enhanced electrode cyclability.

According to the present disclosure, the binder may be a polymeric binder. Binding polymers can include electrode binders as are generally known in the art, examples of which can include, without limitation, polytetrafluoroethylenes (PTFE), carboxymethyl cellulose (CMC), rubbers such as styrene butadiene rubber (SBR) and natural latex rubbers, polyacrylic acids (PAA) such as lithium polyacrylate (LiPAA), polyurethanes, ethylene vinyl acetates, polyacrylamides, starches, polyvinylidene fluoride, acrylonitrile copolymer, polyacrylonitrile, poly(vinylidene fluoride)-hexafluoropropene, or a combination thereof. The binder can be a polymer that upon formation of the electrode is covalently bonded to one or more components of the electrode.

In a conventional electrode processing method, the binder (e.g., PVDF), is dissolved in NMP solvent, resulting in a viscous binder solution. The active material and conductive host, such as sulfur and Vulcan™ (carbon) powders, are mixed in a dry state, and then, combined with a liquid to form a slurry or dispersion. The pre-dissolved binder is then added to the active material/carbon wet dispersion, mixed, coated on the current collector, and dried. As a result, a dense and continuous carbon/binder medium is formed that holds the sulfur particles in place and in contact with the conductive carbon and current collector. Although this slurry preparation and electrode processing method have worked suitably for lithium-ion battery (LIB) electrodes, in the case of sulfur cathode, this compact structure leads to insufficient exposure of sulfur active material to the electrolyte, as well as mechanical degradation of the electrode due to volume variation of sulfur during charge and discharge. As a result, the conventionally made sulfur cathodes suffer from low performance and longevity. Hence, new “out of the LIB box,” affordable, and scalable electrode engineering approaches are required to be tailored for the lithium-sulfur battery (LSB).

Herein, an affordable and scalable electrode processing method, known as “controlled binder-dissolution after dry-mixing (CBAD),” has been developed that can produce highly durable sulfur cathodes using electrode constituents that are readily known in the art. In one embodiment, the sulfur cathode may include a sulfur-containing source. For instance, the sulfur-containing source may include, but is not limited to, sulfur particles in the form of a powder. In one embodiment, sulfur particles can be present in the cathode in an amount of from about 50% by weight to about 95% by weight, such as from about 55% by weight to about 75% by weight, such as from about 60% by weight to about 70% by weight, or any range therebetween. For instance, sulfur particles may be present in the cathode at a concentration of 70% by weight.

In one embodiment, the sulfur can be pre-processed to prepare small-sized particles and de-agglomerating them before electrode fabrication. The sulfur particles may range in size from about 1 μm to about 40 μm, such as from about 5 μm to about 35 μm, such as from about 10 μm to about 25 μm, or any range therebetween.

The sulfur cathode may include a binder. For instance, the binder may include, but is not limited to, polyvinylidene fluoride, styrene butadiene rubber, carboxymethyl cellulose, acrylonitrile copolymer, polyacrylic acid, polyacrylonitrile, poly(vinylidene fluoride)-hexafluoropropene, or a combination thereof. The binder may be present in the cathode in an amount of from about 1% by weight to about 15% by weight, such as from about 2.5% by weight to about 12.5% by weight, such as from about 5% by weight to about 10% by weight, or any range therebetween.

The sulfur cathode can also include electrically conductive particles. In one embodiment, the sulfur cathode may include carbon particles. The carbon particles may include carbon black, activated carbon, carbon fibers, graphitized carbon, or mesoporous carbon. The utilization of sulfur can also be increased by increasing electronic conductivity through the utilization of carbons with higher surface areas, such as Ketjenblack® and sulfur-carbon composites. In general, the electrically active particles are present in the cathode at a concentration of from about 1% to about 25% by weight, such as from about 5% by weight to about 22% by weight, such as from about 10% by weight to about 20% by weight, such as from about 12.5% by weight to about 15% by weight, or any range therebetween.

In one embodiment, the sulfur cathode disclosed herein may include sulfur powder (Sigma-Aldrich, part #414980), carbon black (Vulcan™ XR-72), and polyvinylidene fluoride (PVDF) binder. In one embodiment, the ratio of sulfur-to-carbon-to-binder is about 70:20:10.

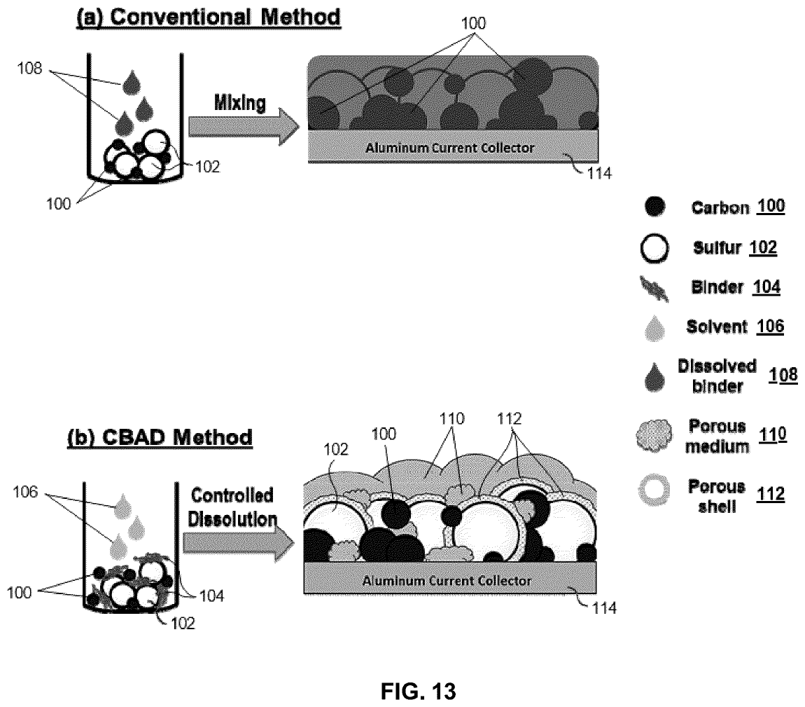

To form an electrode, according to the disclosed process, sulfur 102 (FIG. 13) and binder 104 can initially be individually ground with a pestle and mortar. The carbon 100 can be used as received, depending upon the particle size. Next, the sulfur 102 and binder 104 are mixed and sonicated together in the dry state to ensure a uniform mixture. Subsequently, the dry carbon 100 can be added to the sulfur 102 and binder 104 mix. The dry mixture of sulfur, carbon, and binder can then be sonicated, followed by stirring using a clean and dry magnetic stir bar. Following the formation of the dry mixture, solvent 106 is added to the dry mixture and stirred to form a cathode slurry. In one embodiment, solvent 106 to binder 104 is added to the solution at a ratio of from about 50 μL/mg_{(binder)} to about 300 μL/mg_{(binder)}, such as at a concentration of about 100 μL/mg_{(binder)} to about 200 μL/mg_{(binder)}, or any range therebetween (FIG. 13). Through control of stirring duration and agitation, the kinetics of binder 104 dissolution can be controlled and held at the swollen state—an intermediate dissolution state for polymers that lies between the pure polymer and pure solvent states. The resulting CBAD electrodes can include a sponge-form porous shell 112 of the swollen binder surrounding the sulfur 102 and carbon 100 particles (FIG. 13).

Without wishing to be bound to any particular theory, it is understood that by initially mixing the binder and sulfur powders in the absence of the carbon, the sulfur particles are mixed with a solvent and can later swell and form a porous shell 112 confinement around the sulfur particles (102) within the porous binder medium 110. This porous shell can allow better exposure of the sulfur particles to the electrolyte and accommodate sulfur volume expansion during discharge. These improvements can consequently result in enhanced durability of the electrode. In general, a porous shell 112 structure may define a thickness that is from about 1 μm to about 5 μm, such as from about 1.5 μm to about 4.5 μm, such as about 2 μm to about 3.5 μm, or any range therebetween. Contrarily, conventional sulfur cathode processing method forms a dense and continuous binder medium that tightly holds the sulfur particles and does not provide enough space for sulfur volume expansion during discharge (FIG. 13).

The cyclability of Li—S batteries that incorporate an electrode formed as described herein can thus be improved through control of the dissolution level of the binder into the processing solvent. The result is longer battery life, allowing these cells to penetrate into new applications.

The low-cost and scalable processing method disclosed herein can be used for the formation of highly durable sulfur cathodes containing sulfur, electrically active particles, and polymeric binders. The method is based on the preparation of a sulfur cathode slurry via a simple approach using conventional electrode components. During the formation process, the degree of binder dissolution into the solvent is limited by controlling the diffusion of the solvent into the entangled polymer chains through varying solvent:binder ratio, dissolution time, and agitation. In one embodiment, the dissolution time is from about 20 hours to about 30 hours, such as from about 22 hours to about 27 hours, or any range therebetween. In another embodiment, the agitation time may be from about 300 RPM to about 1000 RPM, such as from about 450 RPM to about 750 RPM, or any range therebetween.

The method used to coat the swollen binder material during formation of a cathode can also be used to provide further improvement to the cathodes. In some embodiments, spraying can be used to form a highly porous swollen binder network. In some embodiments, the sprayed material (commonly termed an electrode ink) can be aerated. Alternatively, using the conventional doctor blade technique can result in a denser cathode while still providing improvements through the swollen binder of the cathode.

In one embodiment, the sulfur cathode disclosed herein may be coated onto a current collector using standard coating techniques known in the art. For instance, the coating technique may be spray coating, which involves layer-by-layer dispersion and deposition of a well-mixed electrode ink onto the current collector. The spraying may be done using an airbrush. As the electrode, only enough material is generally put onto the current collector to cover it entirely. The layer can then be allowed to dry (e.g., at 100° C.) before another layer of ink is sprayed and dried. The process can be repeated until the desired loading was achieved. Lastly, the electrode can be held under vacuum for 48 hours to ensure that all the solvent was removed.

In one embodiment, a coating method may include a doctor blade technique. In this embodiment, a current collector substrate can be placed onto a vacuum table in an enclosure to hold it in place. The homogeneous and well-mixed ink can be placed onto the current collector. The blade can then be slowly moved along the substrate, spreading the ink on the current collector to form a uniform thin layer. The electrode can then be dried, e.g., at room temperature. Because the layer can be dense and drying need not be aided with heat, the doctor blade electrodes can have longer drying times than the spray coated electrodes. It is also worth noting here that when the spray-coated electrodes are formed, only a small amount of ink is used in each step, and drying occurs almost instantly due to the heat and low overall volume of solvent per step. This means that the electrode is never really in a high liquid state (excess solvent) during its formation. During the doctor blade deposition, all of the ink is spread on the current collector at once and drying occurs from a high liquid state.

Independent of the coating method utilized, the cycling performance of the sulfur cathodes prepared through the disclosed methods can exhibit impressive capacity retention of 74% after 1000 cycles, suggesting a considerable improvement in the shuttling effect and active material preservation. Disclosed production processes can be adapted to battery manufacturing and in scale-up of disclosed cells.

Through the controlled dissolution of the binder after dry mixing the electrode components, a porous medium of binder can be formed that offers proper adhesion while facilitating a larger surface area and, thus, enhanced redox reactions. Through this method, called CBAD, combined with the spray coating technique, a protective covering shell structure can be formed around the sulfur particles that impedes the polysulfide dissolution by physical trapping. The shell structures also accommodate the volume expansion of sulfur during discharge and subsequently prevent mechanical degradation in sulfur electrodes. As a result of these structural characteristics, highly durable sulfur cathodes with high capacity are achieved. This finding helps establishing a low-cost and scalable manufacturing process for stable and highly durable sulfur cathodes for LSBs.

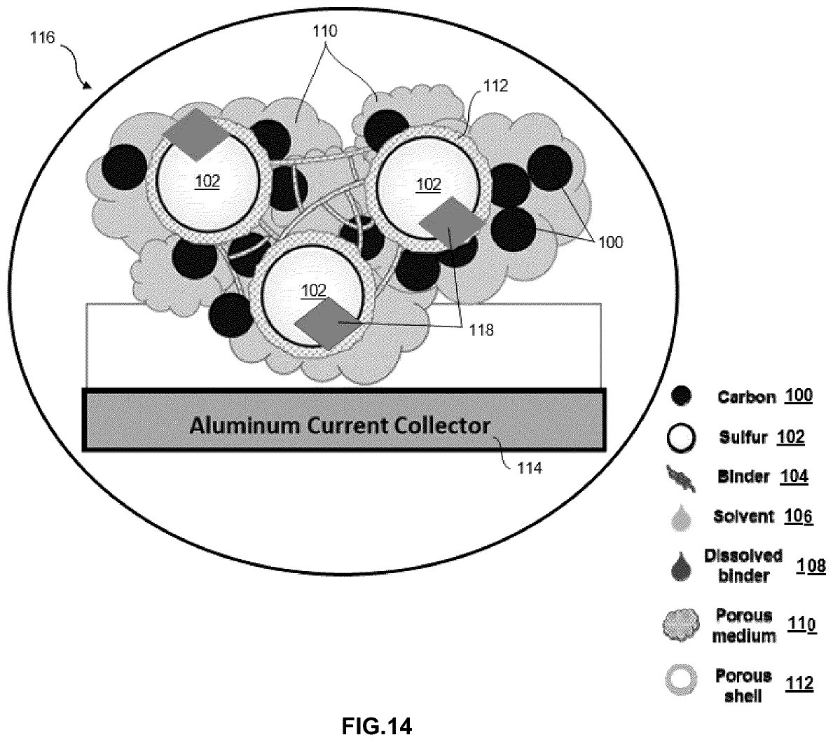

In one embodiment, a cathode formed based on the CBAD method disclosed herein may be incorporated into an electrochemical cell 116 (FIG. 14). The electrochemical cell 116 may include a sulfur cathode, an anode, and a liquid state electrolyte. In one embodiment, the sulfur cathode may include a porous shell 112 in contact with a porous medium. For instance, the sulfur cathode includes, but is not limited to, elemental sulfur (S₈), Li₂Sₓ, or a combination thereof. The general formula Li₂Sₓ in which x is equal to or greater than four. For instance, the cathode active material may be Li₂S₄, Li₂S₅, Li₂S₆, Li₂S₇, or Li₂S₈.

The electrochemical cell may also include an anode. The anode can include a porous anode active material and an anode current collector. In general, metallic lithium or a lithium alloy may be employed as anode active material, so as to take advantage of the high energy density of lithium metal. According to one embodiment, the anode may include silicon, lithium, or a lithiated oxide material. For instance, the lithiated oxide comprises a general formula of LiₓZ_{y}Oₐ in which Z represents a non-metallic element, and x, y, and a are each greater than or equal to one. In one embodiment, lithiated oxide includes, but is not limited to, lithiated silicon, lithiated silicon oxide, or a combination thereof.

In one embodiment, the electrochemical cell may include an electrolyte 116, such as lithium ion conducting particles. For instance, the electrolyte may include, but is not limited to, lithium bis(trifluoromethane)sulfonimide (LiTFSI), lithium hexafluorophosphate (LiPF₆), or a combination thereof. The electrode may separate the sulfure cathode and the anode.

In one embodiment, the electrochemical cell may further include a current collector. For instance, the current collector may include, but is not limited to, aluminum.

In another embodiment, the cathode active material may be a metal oxide intercalation cathode active material as is known in the art. The cathode can include a metal oxide compound in conjunction with other components such as graphite and an electrolyte/binder that can provide ionic transport or can include only the metal oxide intercalation material, as desired.

The metal oxide cathode active material can be prepared having a unit structure characterized by the ability to insert lithium ion in an electrochemical reaction. Such compounds are referred to as intercalation compounds and include transition metal oxides having reversible lithium insertion ability. The transition metal of the cathode active material can include one or more of V, Co, Mn, Fe, and Ni.

The electrochemical cells can provide high-energy density, high cycling rates (high power capability) and safe battery technology. The electrochemical cells can be used to form lightweight metal-supported solid state lithium ion batteries that can meet existing challenges in battery technology. Moreover, the electrochemical cells can find immediate applications in electric vehicles, aerospace applications, and in renewable and grid energy storage, among others.

A battery may include one or more of the cells sealed into a case according to standard methodology. For instance, the battery may be a lithium-sulfur battery.

Furthermore, certain aspects of the present disclosure may be better understood according to the following examples, which are intended to be nonlimiting and exemplary in nature. Moreover, it will be understood that the compositions described in the examples may be substantially free of any substance not expressly described.

### Examples

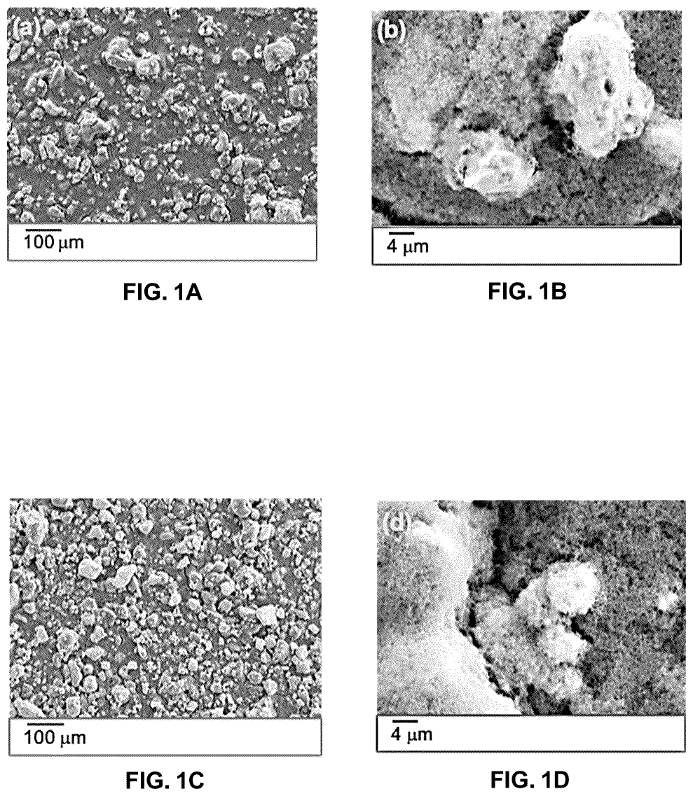

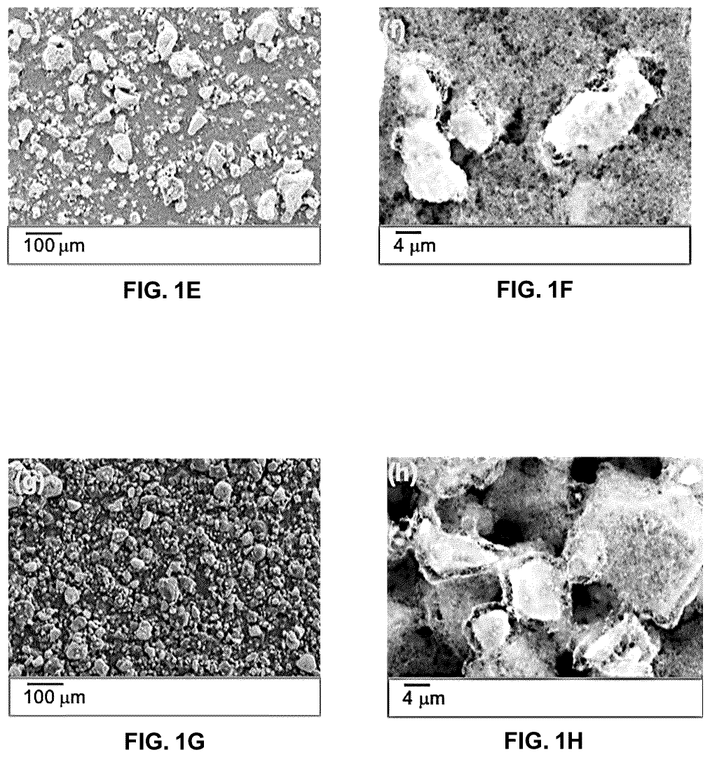

In order to investigate the effect of preparation methods on the structure and electrochemical performance of sulfur cathodes, slurries produced by both the conventional and the disclosed CBAD method were coated on aluminum (Al) foil as the current collector. Considering the additional effect of coating process on the electrode structure, two coating techniques, doctor blade and spray, were investigated for each slurry. After coating, all four electrodes were dried under vacuum at room temperature for 48 hrs. Results of the structural characterization and electrochemical assessment on these electrodes are presented in FIG. 1.

An agglomerated sulfur structure was observed in all four electrodes. Nevertheless, doctor blade coating process resulted in a wider particle size distribution (average size 33.2-33.3 μm and larger sized aggregates (FIGS. 1A and 1E) while the spray method (FIG. 1C and FIG. 1G) formed notably more uniform structure and homogeneous particle size distribution. This is attributed to the spray-induced atomization of the slurry that provides a more uniform coating layer with finer agglomerates.

Furthermore, a porous binder medium was observed in all four electrodes. However, the electrodes that were sprayed displayed a less dense and more spongy-form porous medium (FIG. 1D and FIG. 1H) when compared to those that were doctor-bladed (FIGS. 1B and 1F). Interestingly, when spray coating and CBAD method were combined, as shown in FIG. 1H, a noticeable difference in the electrode microstructure was observed where the fine shell-like structures confined the sulfur particles. The shell covering, however, appears but very faint in the CBAD electrode prepared by doctor blade method (FIG. 1F) and it was absent when a conventional slurry making approach was adopted irrespective of coating method (FIG. 1B and FIG. 1D). These observations suggest that it is the combination of the CBAD method and the spray coating that results in the desired porous shell structures around sulfur particles.

The pre-cycling structure of the spray- and doctor blade-coated CBAD and conventional electrodes were characterized using a high-resolution field emission scanning electron microscope (FE-SEM), Zeiss™ Gemini 500 FE-SEM. Microscopy may be performed at about 8 mm to about 12 mm working distance using a 15 kV acceleration voltage for the electron beam and a highly efficient secondary electron detector.

The spray- and doctor blade-coated CBAD and conventional electrodes were then incorporated into coin cells. Specifically, each electrode was punched to a 16 mm diameter disk using a precision disk cutter (MTI Corp.), followed by use of a cathode in a coin cell. In a typical procedure, a 16 mm diameter Li metal foil (99.9%, Alfa Aesar) as anode was placed at the center of a coin cell base, then 10 μL/mg_{(active material in cathode)} of electrolyte, which consisted of 1 M LiTFSI (Sigma-Aldrich, USA) salt in a commonly used ether-based solvent mixture: 1:1 ratio by volume of dimethoxyethane (DME, 99%, Sigma-Aldrich) and dioxolane (DIOX, 99%, Sigma-Aldrich) and 2 wt % of LiNO3 (99%, Alfa Aesar) as additive, was uniformly fed onto the Li foil. Next, a separator (Celgard® 2320 tri-layer polymer (diameter: 19 mm)) was centered on top, followed by another 10 μL/mg_{(active material in cathode)} dose of electrolyte. After, a gasket was placed along the peripheral of the coin cell base to ensure proper sealing of the coin cell. Next, the sulfur cathode disk was centered on top of the Li/electrolyte/separator/electrolyte stack, with the electrode material facing the separator. A spacer disk and spring were also used to distribute the pressure and electrical continuity uniformly. Finally, the cap of the coin cell was placed on top, and the coin cell was sealed using an MTI hydraulic press (MSK-110) at a pressure of 750 psi. The coin cells were assembled inside of an argon-filled (ultra-high purity 5.0 argon, Airgas®) MBRAUN LABmaster SP glove box with oxygen and humidity content of <0.1 ppm.

After cell assembly, all four electrodes (conventional doctor blade-coated, conventional spray-coated, CBAD doctor blade-coated, and CBAD spray-coated) were tested for their cycle performance using an Arbin battery cycler (Version 3.0 Build 7.29). The cells were not aged or conditioned prior to cycling test. The cycle performance of the cells was investigated through a constant current (CC) cycling at 0.1 C from 1.8 V to 2.8 V. The long-term cycling of the best performing cell was studied up to 1000 cycles. The C-rate capability of the best performing cell was evaluated by 10 cycles at each 0.1 C, 0.2 C, 0.5 C, and 1 C-rates and reversing it back to 0.1 C.

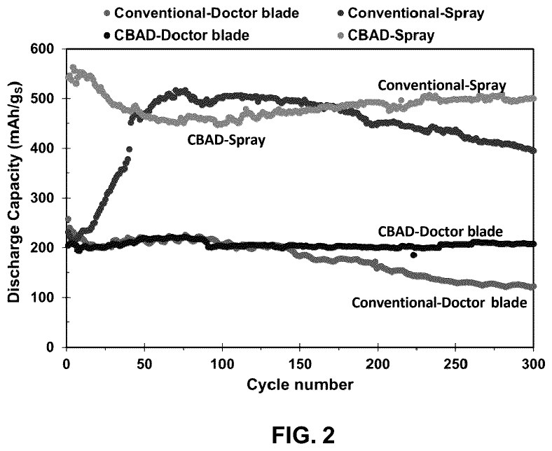

The cells were tested for their cycle performance at C/10 for 200 cycles. The cells were allowed to equilibrate at C/10 for several cycles. Their discharge performance of the subsequent 200 cycles after equilibrium at C/10 is shown in FIG. 2 and it is considered that the discharge capacities of the cells were highly influenced by the electrode preparation method. As indicated, the cells made from a spray coating method had significantly higher discharge capacity as compared to their counterparts made from a doctor blade method. This spray coating method resulted in smaller and uniform active particles. However, the smaller particles have better exposure and this facilitates improved conversion reaction as opposed to bigger agglomerates produced by the doctor blade technique. The large agglomerate size in the doctor blade electrode left a large part of the particles unreacted resulting in low capacity. However, in each group, electrodes produced from CBAD method provided stable discharge capacity.

In the conventional electrodes, capacity degradation took place after few cycles. A major route through which capacity reduces for Li—S battery is through lithium polysulfides (LiPSs) shuttling. The discharge behavior observed here is understood by studying the evolution of the voltage profiles at several cycles.

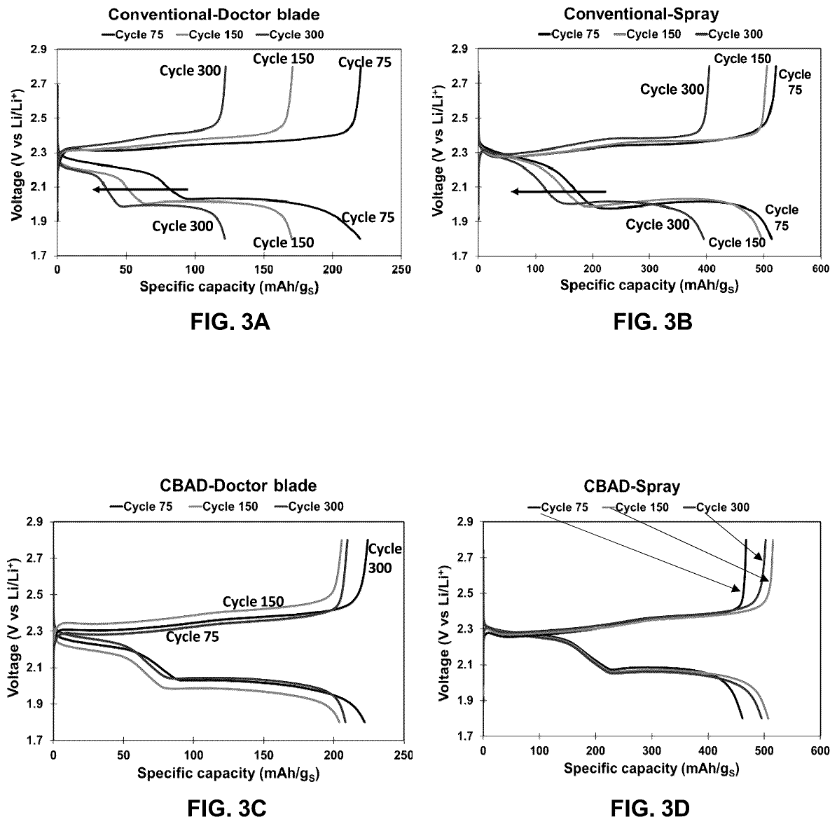

The charge and discharge profiles of the four sulfur electrodes within the voltage window of 1.8 V-2.8 V was observed at cycles 50, 100, and 150 and shown in FIG. 3. As observed, the voltage profiles of the electrodes combined of two distinguishable plateaus showing the formation of higher order lithium polysulfides at higher voltage and short chain polysulfides at lower voltage. The plateau at higher voltage plateau represents the formation of soluble LiPSs, while the lower voltage plateau indicates the further reduction of LiPSs to insoluble Li₂S₂/Li₂S products. The loss of LiPSs can be quantified by the ratio of the capacities of these two plateaus. A reduction in the higher voltage indicates that a loss of polysulfide.

As observed, there was a reduction in the length of the higher voltage plateau in the conventional electrodes (FIG. 3A and FIG. 3B) from cycles 50-150 irrespective of the coating technique used. This signifies a loss of LiPSs that would have participated in the subsequent cycles, and this manifests in the capacity fading observed. Remarkably, this phenomenon was not observed in the CBAD electrodes where length of the plateaus stays the same throughout showing that the soluble long chain polysulfides are not permanently lost during cycling. Hence, the CBAD electrodes produced a stable capacity throughout the 200 cycles the electrodes were tested.

Several binder compositions have been explored. PVDF does not have the polysulfide anchoring ability. Hence, the polysulfide containment ability of the particular electrodes can be attributed to the novel electrode processing technique which resulted in the shell covering around the sulfur particles. As a result, the out-migration of the soluble polysulfides can be significantly decreased by trapping inside the porous shell and long transport length provided by the shell with conversion in subsequent cycles

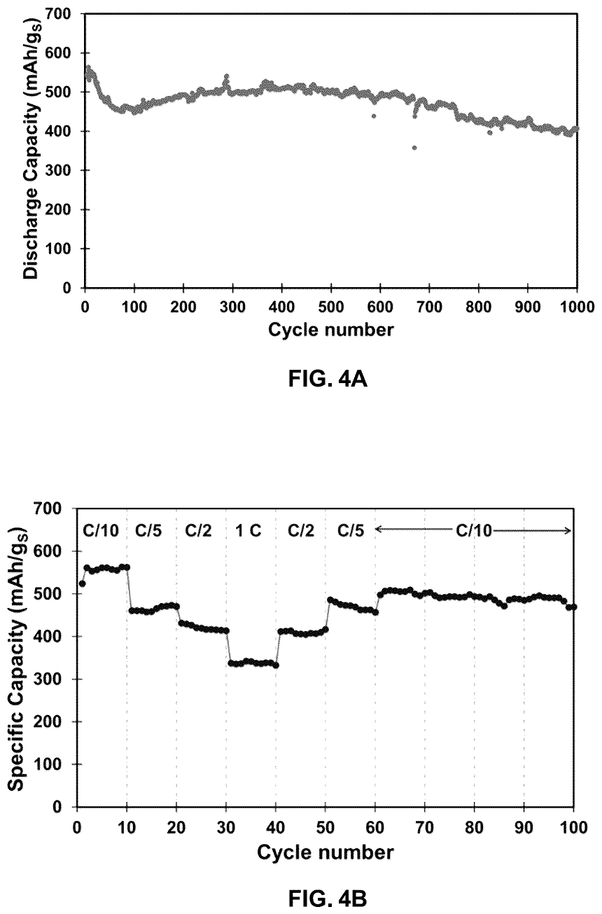

Because of the excellent initial cycling behavior of the CBAD-spray electrode, this electrode was tested for its long cycle life up to 1000 cycles (FIG. 4A). In one embodiment, electrodes as disclosed herein can retain greater than 70% of capacity after about 1000 charge-discharge cycles relative to the initial charge-discharge cycle. An initial capacity of 451 mAh/g was observed in the first cycle of one exemplary electrode. The capacity astoundingly increased to its highest of 543 mAh/g at around 300 cycles. Up to 700 cycles, the CBAD-spray cathode offered an average capacity of 500 mAh/g with a retention percentage of 90%. The final capacity of this electrode at 1000 cycles was 400 mAh/g offering a remarkable 74% of capacty retention. It is worth noting that so far this is the highest achievable capacity and cyclability for Li—S battery produced through a simple, and scalable processing technique using the commercially available and cost-effective materials.

The rate capability of a CBAD-spray electrode was also assessed by cycling the cell at different C-rates as shown in FIG. 4B. At C/10, the cell maintained about 550 mAh/g of capacity which decreases to about 310 mAh/g at 1 C. Lower capacities at high current rates are expected. However, the cell regained almost all its capacity when returned at a lower C-rate suggesting the reasonable kinetics and charge and discharge transfer in this electrode. The achieved discharge capacity in this method was lower than the theoretical capacity likely due to the inaccessibility of all parts of the sulfur particles, as large agglomerates might cause the low utilization of the active material.

### Example 1

Different sulfur cathodes were fabricated with identical ingredients (70% sulfur, 20% conductive carbon, and 10% binder). All the components were mixed in dried form but with different solvent system (Table 1). For all cathode classes 1 and 2, the powdered ingredients were mixed and stirred in the solvent for 24 hours. For the class 3, the components were mixed for 1 week. In all the electrodes, the required amount of solvent that forms a sprayable viscosity is used. Due to the different solubility tendencies of the solvents, the amount of water and NMP used varied slightly, but each was consistent within the same class.

Galvanostatic charge-discharge tests were conducted in an Arbin® battery tester with the voltage range 1.8 V-2.8 V at room temperature at C/10 current density. The naming of each cell in Table 1 follows the pattern B-S-x where B stands for the binder used (CM for CMC, PV for PVP and PA for PAA); S=solvent used (N for NMP and W for Water); x=class group of the electrodes denoting stirring time (1=inks stirred for 1 day). For example, a CMC-based electrode in 5 μL/mg electrode materials water stirred for 24 hours is designated as CM-W-1.

TABLE 1
Cathodes prepared with different solvent dissolution regimes.

| | | | Solvent amount | |
|---|---|---|---|---|
| | | | (per mg of | Time of |
| | Binder | Solvent | electrode | stirring |
| Cathode | type | type | component) (ml) | (days) |
| CM-W-1 | CMC | Water | 5.0 | 1 |
| PA-W-1 | PAA | Water | 5.0 | 1 |
| PV-W-1 | PVP | Water | 5.0 | 1 |
| CM-N-1 | CMC | NMP | 5.0 | 1 |
| PA-N-1 | PAA | NMP | 5.0 | 1 |
| PV-N-1 | PVP | NMP | 5.0 | 1 |
| CM-N-2 | CMC | NMP | 25.0 | 1 |
| PA-N-2 | PAA | NMP | 25.0 | 1 |
| PV-N-2 | PVP | NMP | 25.0 | 1 |
| CM-N-3 | CMC | NMP | 25.0 | 7 |
| PA-N-3 | PAA | NMP | 25.0 | 7 |
| PV-N-3 | PVP | NMP | 25.0 | 7 |

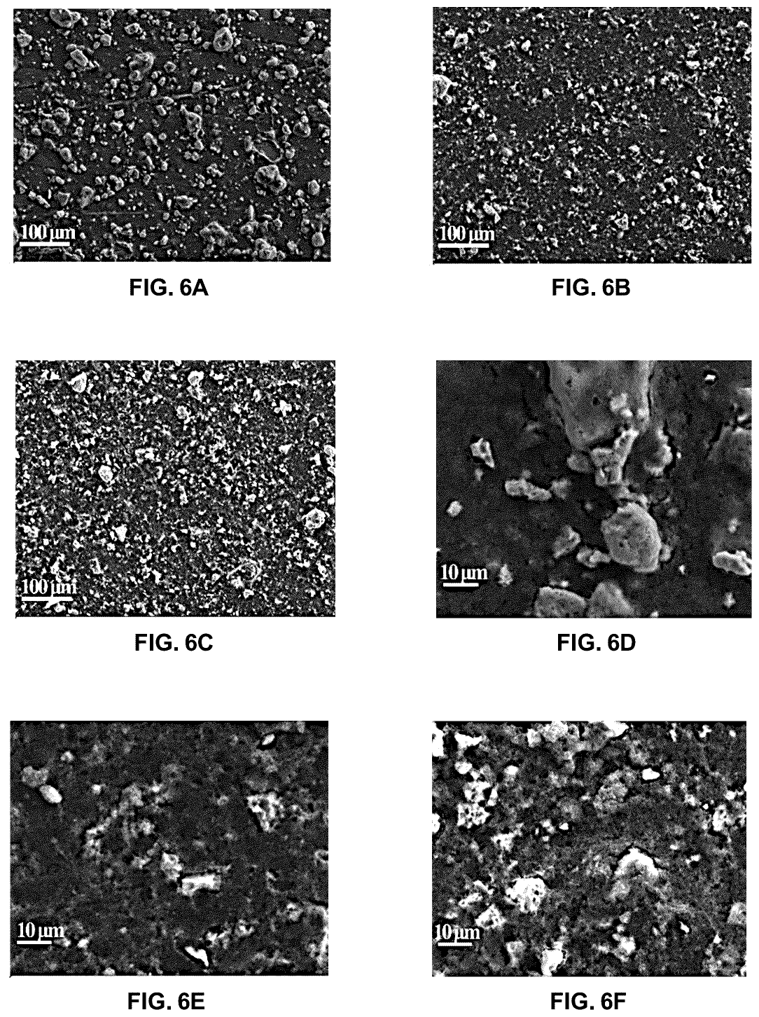

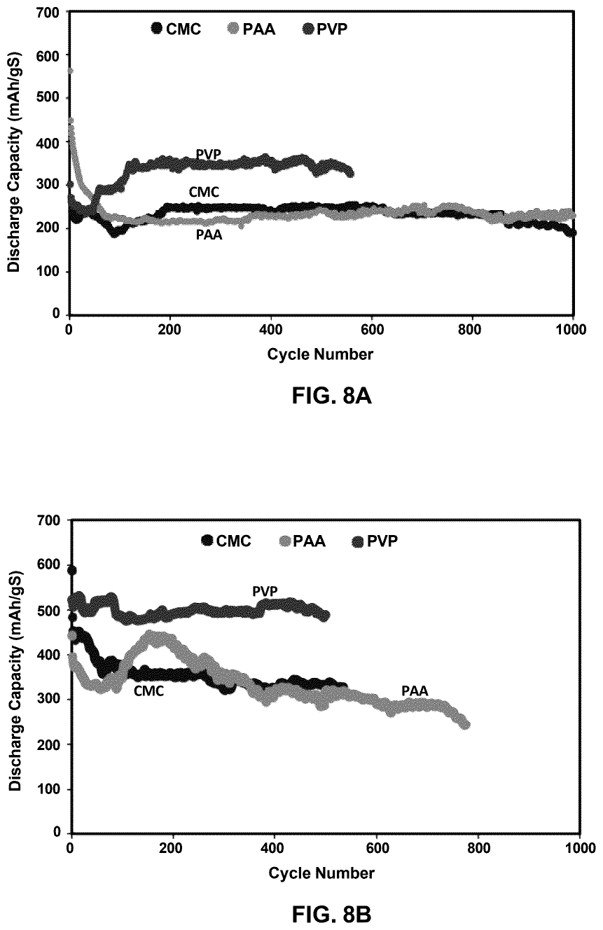

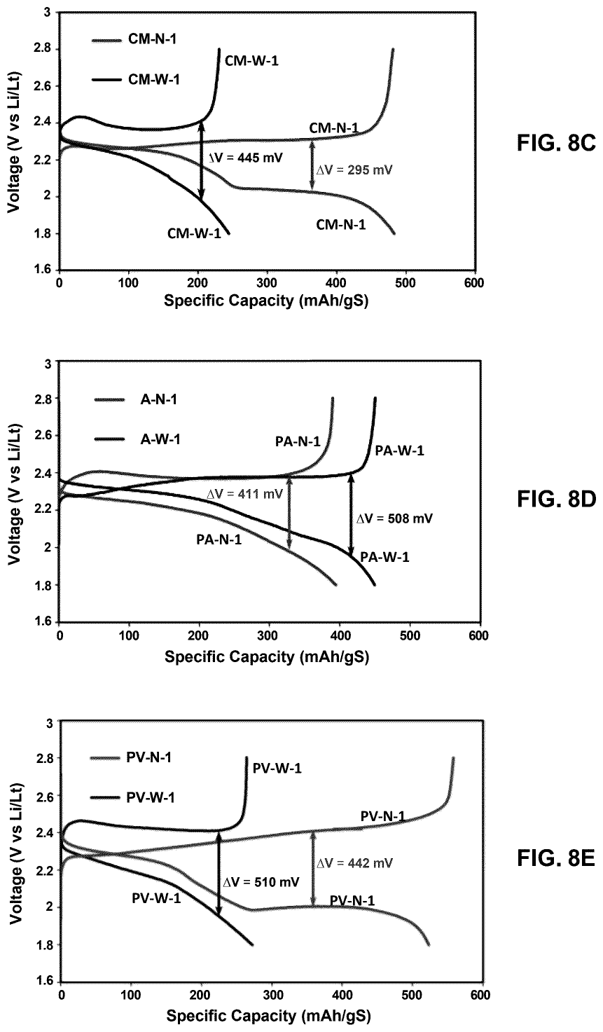

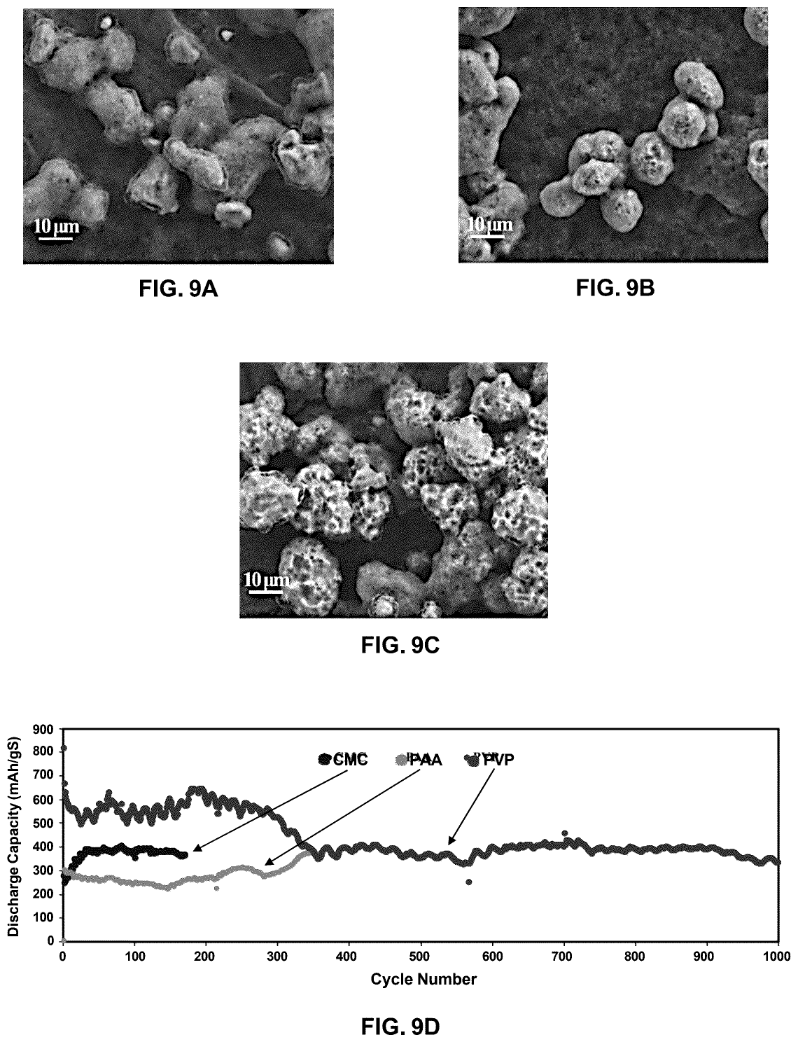

A morphological examination was conducted using the scanning electron microscope (SEM) to investigate the effects of binder dissolution environment on the physical microstructure of the electrodes. FIGS. 6A-6F depict the SEM images of the electrodes in water and NMP solvents, respectively. As observed, the cathodes structures are composed of fine particles that are distributed throughout the electrode matrices. In the NMP-processed electrodes (FIG. 8), the particles appear more finely dispersed on the current collector. Due to the hydrophobic character of sulfur and carbon particles, the dispersion is inferior thus causing the individual sulfur particles to be isolated in the aqueous-dissolved binders.

A noticeable difference between the morphologies of the two classes of electrodes was observed. For instance, the shell-like structure encapsulating the individual sulfur particles in the NMP-processed electrodes, irrespective of the binder used whereas such shell covering is not observed in the aqueous system. A deeper look into the structure with high magnification SEM imaging, it is seen that the size of the shell around the particles varies; the PAA-based electrode possesses a thin shell, while the shell in both PVP and CMC-based electrodes are large and more visible. The thickness of the shell covering ranges between 1 μm-5 μm.

The ink viscosity in all the electrodes fabricated are similar. This significant difference in the morphological structure of the electrodes, irrespective of the binder used can be attributed to the chemical interaction of the solvent with the binder. PAA, PVP and Na-CMC have oxygen atoms attaching to the carbon backbones which are hydrogen bonding acceptors enhancing their solubility in water. As a result, the water-processed electrodes are dense with particles close to one another. However, NMP is an aprotic solvent which does not form hydrogen bonding and would not penetrate the binder to swell and dissolve it which forms a shell around the particles after drying.

### Example 2

To investigate the influence of the electrode preparation process on the electrochemical performance of the sulfur cathode, galvanostatic charge-discharge cycling was carried out at 0.1 C-rate (C) at room temperature between 1.8-2.8V. The long-term cycle performance is compared in FIG. 8A and FIG. 8B. In all the cells, an initial irreversible capacity loss due to the reduction of sulfur to form solid electrolyte interface is observed. For the NMP system, the initial capacities of the cells are similar around 614 mAh/gS. After 1000 cycles, the specific discharge capacity of PV-N-1 cathode stabilizes at around 500 mAh/gS which is higher than those of CM-N-1 and PA-N-1 sulfur cathodes. By comparison, similar experiments performed on the aqueous based cathodes with the same electrode components and composition but with water as a solvent shown in FIG. 8B shows a much lower discharge performance at the same conditions of testing. Among all the cells prepared in aqueous system, PV-W-1 cathode shows a higher discharge capacity but nevertheless lower than that of PV-N-1. Generally, all aqueous-processed cathodes displayed lower discharged capacities than their NMP-based counterparts. Moreover, the capacity fading after prolonged cycling is less intense in the NMP-based electrodes. This combined improved electrochemical performances, in terms of higher discharge capacity and lower capacity fading rate, is attributed to the unique structure of the electrode which shows a shell covering the active particle. In one way, the shell ensures better accessibility to higher sulfur surface for reaction leading to better utilization of sulfur. It also provides buffer for volumetric expansion for long-term cycling as well as providing better diffusion path for lithium ion.

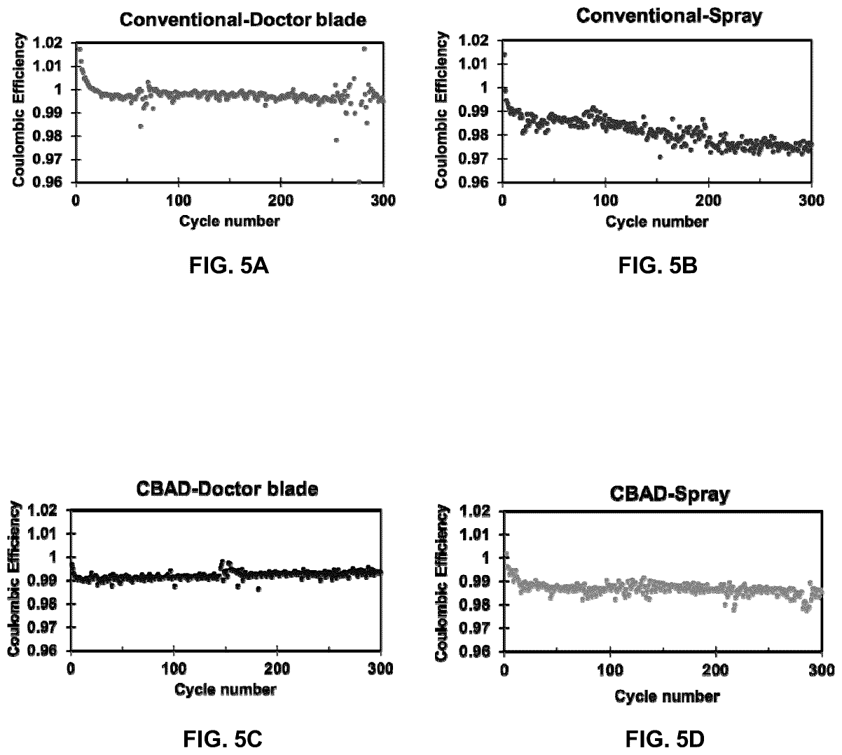

As shown in FIGS. 3C-3E, the voltage difference between the charge and discharge plateaus (ΔV) at the 2nd cycle is larger in aqueous processed cathodes, which is caused by hydrophobicity of the active electrode components. This hydrophobicity that causes poor dispersion leads to high polarization. The effect of the poor dispersion and high polarization is also noticed in the Coulombic Efficiency as shown in FIG. 5. Generally, the Coulombic Efficiency of the aqueous electrodes are lower than in the NMP-based electrodes justifying the compatibility of the electrode ingredients with the solvent in the method adopted for the electrode fabrication.

The lower capacity fading rate observed NMP-based cells can also be rationalized to the shell-like morphology of the electrodes. Most of the capacity fading in Li—S battery is majorly through the transitioning of soluble lithium polysulfides into the electrolyte. The shell covering, besides other functions, also performs to house the polysulfide by providing physical confinement against diffusion into the electrolyte. Hence, redox reaction can take place within the shell space containing the polysulfides. The effect of the shell covering in confining the LPS is shown by almost-constant ratio of the high potential plateau to the lower plateau (QH/QL) across different cycles. Decreasing ratio is an indication of LPS loss. The ratio of QH to QL as shown in Table 2 for cycles 50, 100, and 500 for all the cells indicates that the presence of the shell in the NMP-based cells is crucial in preventing the loss of LPS causing better capacity retention. Hence, this enhanced electrochemical performance could be caused by better Lithium-ion diffusion, confinement of lithium polysulfides and robust mechanical property of the electrode through the formation of the unique shell covering around the particles.

TABLE 2
Ratio of QH to QL of the cathodes at 50^{th}, 100^{th} and 500^{th} cycles.

| | 50^{th} cycle | | | 100^{th} cycle | | | 500^{th} cycle | | |
|---|---|---|---|---|---|---|---|---|---|
| | Q_{H} | Q_{L} | Q_{H}/Q_{L} | Q_{H} | Q_{L} | Q_{H}/Q_{L} | Q_{H} | Q_{L} | Q_{H}/Q_{L} |
| CM-W-1 | 149.5 | 81.1 | 1.84 | 121.3 | 75.1 | 1.61 | 142.7 | 105.1 | 1.36 |
| PA-W-1 | 168.7 | 95.7 | 1.76 | 133.9 | 89.3 | 1.50 | 131.8 | 110.9 | 1.19 |
| PV-W-1 | 267.4 | 113.1 | 2.36 | 230.2 | 107.8 | 2.14 | 175.8 | 164.6 | 1.07 |
| CM-N-1 | 208.2 | 175.5 | 1.18 | 175.5 | 190.8 | 0.92 | 160.1 | 172.7 | 0.93 |
| PA-N-1 | 271.5 | 145.7 | 1.86 | 282.8 | 153.1 | 1.85 | 249.4 | 138.5 | 1.8 |
| PV-N-1 | 258.3 | 260.1 | 0.99 | 246.5 | 238.5 | 1.03 | 242.3 | 247.4 | 0.98 |

The dynamics of shell covering, and subsequent electrochemical performance of the cell is further elucidated by increasing the volume of the solvent as well as the stirring time. First, an excess volume of NMP solvent was added to the electrode materials and stirred for 24 hours. The SEM images and capacity retention of the resulted CM-N-2, PA-N-2 and PV-N-2 are presented in FIG. 4. The SEM images show that the shell covering is completely disappeared in PA-N-2 while it is getting shrunk in CM-N-2 and PV-N-2 cathodes too. This indicates that increasing the volume of the solvent forms a diluted environment around the sulfur particles which reduces the tendency to form a sturdy shell when dried. This variation in the appearance of the shell results from different degree of dissolution of the polymer in the solvent. Consequently, it affects the morphology of the electrode. This effect is manifested in the capacity retention plot shown in FIG. 4B. The discharge capacity of the cells is much lower than those obtained in FIG. 3B for the same cathode component further highlighting the significance of the shell covering in enhancing the physical characteristics of the cells.

### Example 3

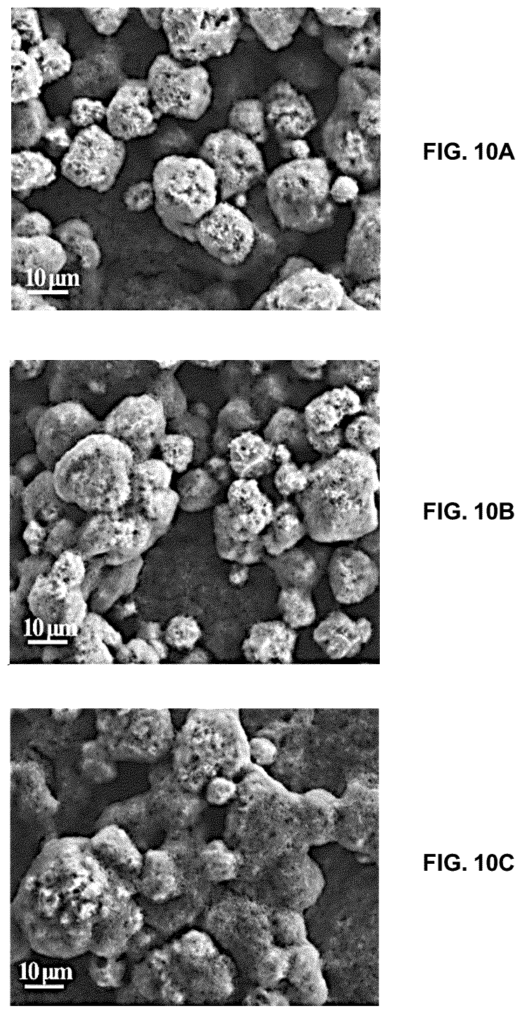

To further understand the dissolution dynamics of the binders in the solvent, an extended stirring time for an excess amount of solvent is used. From the morphological examination through the SEM as shown in FIGS. 10A-10C, the shell covering that initially encapsulated the active sulfur particle has now been completely disappeared. This phenomenon is dictated by polar-induced interaction among the NMP molecules resulting in antiparallel arrangement of the NMP rings when the population of the NMP molecule is increased.

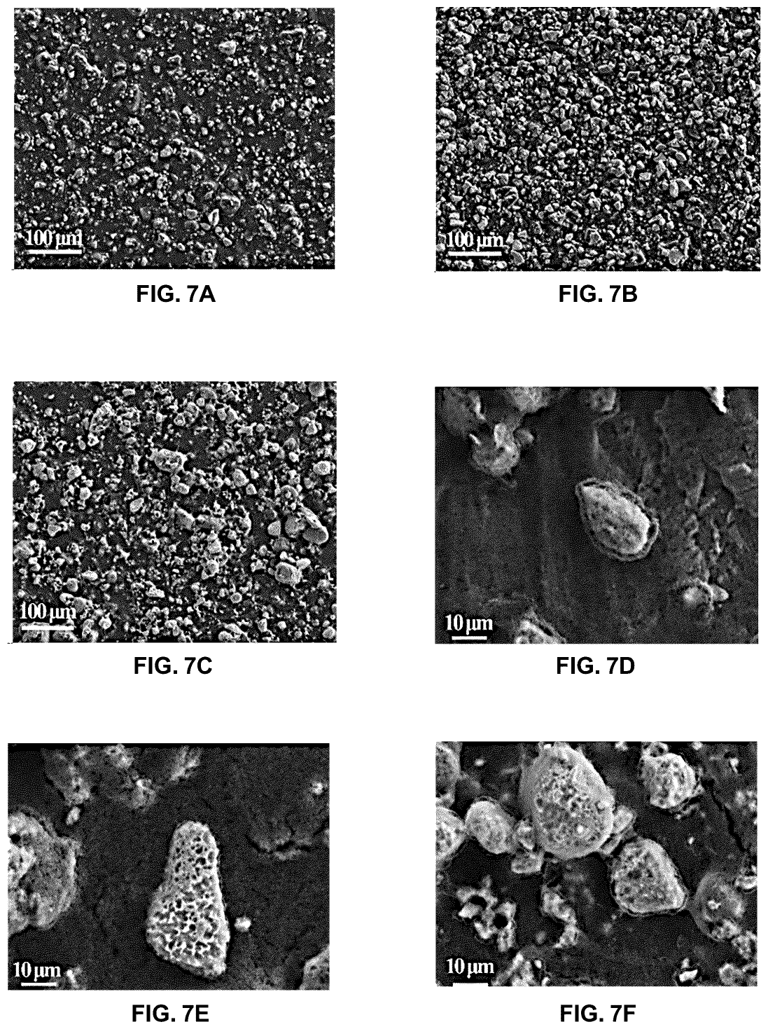

Galvanostatic cycling shows an initial high discharge capacity which gradually fades as the cycling proceeded. Both the discharge capacity and capacity retention for each cathode are significantly lower than the reference cells in FIG. 7B again signifying the positive influence of the shell covering on the morphology and electrochemical performance.

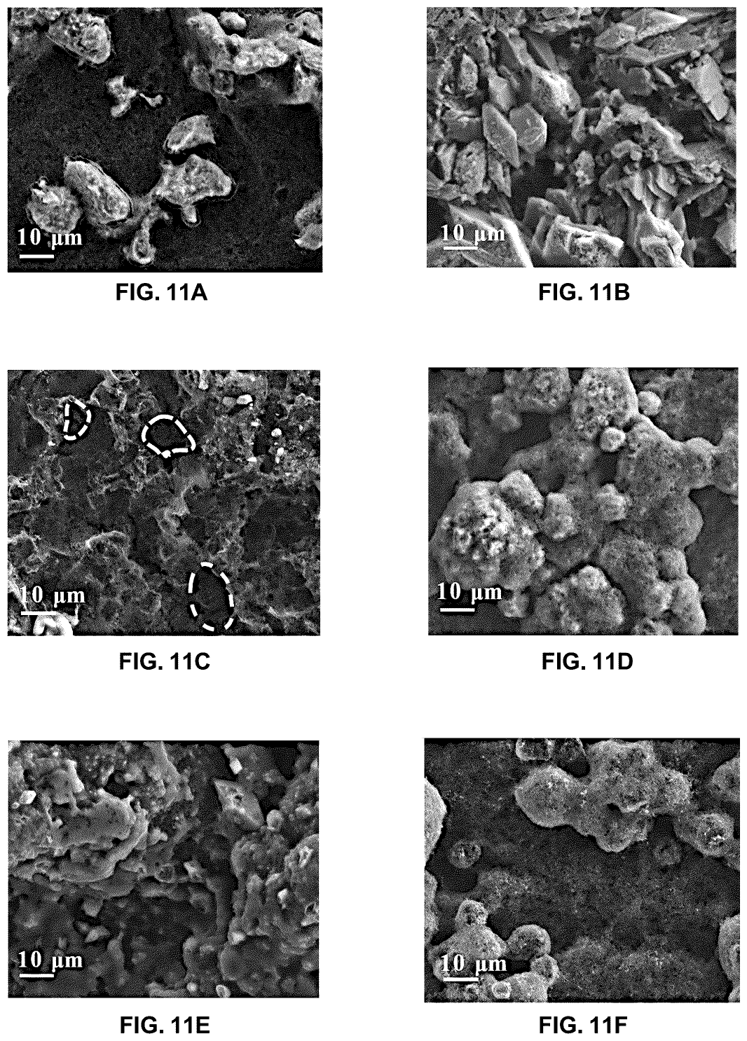

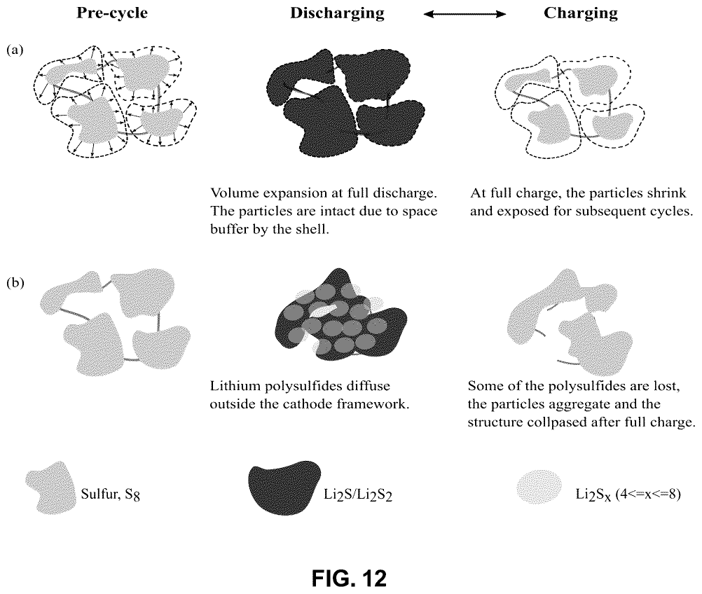

A postmortem SEM analysis of the structure of the top view of the cathode surface after 20 galvanostatic cycling of PV-N-1 is carried out as shown in FIG. 11 to show the impact of the shell during cycling. After 20 cycles of charge and discharge processes, the fully lithiated state of PV-N-1 still possesses a neat structure composing of sulfur particles uniformly distributed on the current collector. Also, the particles appear larger depicting an expanded particle due to discharge process that led to the formation of the Li₂S product. Treating the electrode with dimethoxyethane (DME) to dissolve the species on the surface leaves a hole, depicted by white dashed oval shapes, of the same shape as the shell covering encapsulating the particles. Contrarily, the surface of the PV-N-3 is covered by large deposits of discharged products illustrating that the dissolved polysulfides are not confined within the cathode structure. This deposition of discharge products on the electrode surface is one of the reasons for low capacity, because of surface covering that limits accessibility of the active sulfur surface, and capacity fading by wasting away the polysulfides. Several other approaches have been deployed to ensure better electrochemical deposition and diffusion of lithium polysulfides including creating a physical barrier through design of separator, creating an interlayer protection on the surface of the cathode, and even on the anode to prevent the reaction of the polysulfide with lithium metal and creating a physical barrier by encapsulating sulfur particles inside carbon nanosphere and nanotube. The protection of electrode integrity has also been shown to influence cathode performance by protecting the particle against mechanical damage. It appears that the shell covering the sulfur particle is performing the dual functions of creating a mechanical buffer against particle destruction as well as physically trapping the lithium polysulfides as shown in FIGS. 11A-11B.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A method of producing a sulfur cathode, the method comprising:
dry mixing sulfur particles and a binder;
adding a carbon source to the dry mixture; and
contacting the resulting dry mixture comprising the carbon source, the sulfur particles, and the binder with a solvent to form a cathode slurry, and
removing the solvent from the cathode slurry to form the sulfur cathode, wherein the sulfur cathode comprises a plurality of particles, each particle including a porous shell structure covering one or more of the sulfur particles.

2. The method of claim 1, wherein the porous shell structure comprises carbon of the carbon source and at least a portion of the binder.

3. The method of claim 1, wherein the porous shell structure defines a thickness that is from about 1 μm to about 5 μm.

4. The method of claim 1, wherein the sulfur particles comprise sulfur powder.

5. The method of claim 1, wherein the dry mixture comprises the sulfur particles in an amount of from about 55% to about 95% by weight.

6. The method of claim 1, wherein the dry mixture comprises the binder in an amount of from about 1% to about 15% by weight.

7. The method of claim 1, wherein the binder comprises a polymeric binder.

8. The method of claim 7, wherein the polymeric binder comprises a polymer selected from the group consisting of polyvinylidene fluoride, styrene butadiene rubber, carboxymethyl cellulose, acrylonitrile copolymer, polyacrylic acid, polyacrylonitrile, poly(vinylidene fluoride)-hexafluoropropene, and a combination thereof.

9. The method of claim 1, wherein the carbon source comprises carbon black, activated carbon, carbon fibers, graphitized carbon, or mesoporous carbon.

10. The method of claim 1, wherein the solvent comprises n-methyl-2-pyrrolidone, dimethoxyethane, dioxolane, water, or a combination thereof.

11. The method of claim 10, wherein the cathode slurry comprises the solvent at a concentration of from about 50 μL/mg_{(binder)} to about 300 μL/mg_{(binder)}.

12. An electrochemical cell, comprising:
a sulfur cathode comprising a plurality of particles, each particle comprising a porous shell structure covering one or more sulfur particles, the porous shell structure comprising a binder and carbon;
an anode comprising silicon, lithium, or a lithiated oxide; and
an electrolyte separating the sulfur cathode and the anode.

13. The electrochemical cell of claim 12, wherein the electrochemical cell further comprises a current collector.

14. (canceled)

15. The electrochemical cell of claim 12, wherein the lithiated oxide comprises a general formula of LiₓZ_{y}Oₐ in which Z represents a non-metal, and x, y, and a are each greater than or equal to one.

16. The electrochemical cell of claim 12, wherein lithiated oxide comprises lithiated silicon oxide.

17. The electrochemical cell of claim 12, wherein the sulfur particles comprise elemental sulfur (S₈).

18. The electrochemical cell of claim 12, wherein the electrolyte comprises lithium bis(trifluoromethane)sulfonimide (LiTFSI), lithium hexafluorophosphate (LiPF₆), or a combination thereof.

19. The electrochemical cell of claim 12, further comprising an additive present in the electrochemical cell at a concentration of from about 1% by weight to about 5% by weight.

20. The electrochemical cell of claim 19, wherein the additive comprises lithium nitrate.

21. A battery comprising the electrochemical cell of claim 12, wherein after about 100 charge-discharge cycles, the battery exhibits a capacity that is greater than about 70% of the capacity at an initial charge-discharge cycle.
